(19) United States
(12) Patent Application Publication
(10) Pub. No.: US 2013/0024926 A1
(43) Pub. Date: Jan. 24, 2013

(54) AUTHENTICATION APPARATUS, SERVICE PROVIDING SYSTEM, AND COMPUTER READABLE MEDIUM

(71) Applicants: Takashi SAKAYAMA, Kanagawa (JP); Shigeru TANABE, Kanagawa (JP)

(72) Inventors: Takashi SAKAYAMA, Kanagawa (JP); Shigeru TANABE, Kanagawa (JP)

(73) Assignee: FUJI XEROX CO., LTD., Tokyo (JP)

(21) Appl. No.: 13/464,224

(22) Filed: May 4, 2012

(30) Foreign Application Priority Data
Jul. 21, 2011 (JP) 2011-159780

(51) Int. Cl. G06F 21/00; G06F 7/04

(52) U.S. Cl. 726/7

(57) ABSTRACT

An authentication apparatus includes following components. In an authentication table, first authentication information, login information, and second authentication information are associated. A communication unit communicates with another apparatus. A first login processing unit compares identification information with the first authentication information, and rewrites the login information to a logged in state and notifies the other apparatus of successful authentication when the identification information matches the first authentication information. The logout processing unit compares identification information with the first authentication information, and rewrites the login information to a logged out state when the identification information matches the first authentication information. The second login processing unit compares the identification information with the second authentication information, and notifies the other apparatus of successful authentication when the identification information matches the second authentication information and the corresponding login information indicates the logged in state.

### CROSS-REFERENCE TO RELATED APPLICATIONS

This application is based on and claims priority under 35 USC 119 from Japanese Patent Application No. 2011-159780 filed Jul. 21, 2011.

### BACKGROUND

(i) Technical Field

The present invention relates to an authentication apparatus, a service providing system, and a computer readable medium.

(ii) Related Art

Apparatuses are known which provide users with various services, such as a print function, a scan function, a copy function, and a facsimile function. When users utilize such services, authentication is requested in order to check whether or not the users have rights. This process of authentication is carried out in the apparatuses or other authentication apparatuses.

### SUMMARY

According to an aspect of the invention, there is provided an authentication apparatus including an authentication table, a communication unit, a first login processing unit, a logout processing unit, and a second login processing unit. In the authentication table, first authentication information, login information, and one or more pieces of second authentication information are stored in association with each other. The login information indicates a logged in state or a logged out state of a user related to the first authentication information. The one or more pieces of second authentication information are different from the first authentication information. The communication unit communicates with another apparatus. The first login processing unit compares identification information received along with a login request from the other apparatus via the communication unit, with the first authentication information by referring to the authentication table. When the identification information matches the first authentication information, the first login processing unit rewrites the login information associated with the first authentication information to the logged in state, and notifies the other apparatus of successful authentication via the communication unit. The logout processing unit compares identification information received along with a logout notification from the other apparatus via the communication unit, with the first authentication information by referring to the authentication table, and rewrites the login information associated with the first authentication information to the logged out state when the identification information matches the first authentication information. The second login processing unit compares the identification information received along with the login request from the other apparatus via the communication unit, with the one or more pieces of second authentication information by referring to the authentication table, and notifies the other apparatus of successful authentication via the communication unit when the identification information matches a piece of second authentication information among the one or more pieces of second authentication information and the login information associated with the first authentication information that is associated with the matching piece of second authentication information indicates the logged in state.

### BRIEF DESCRIPTION OF THE DRAWINGS

An exemplary embodiment of the present invention will be described in detail based on the following figures, wherein:

FIG. 1 illustrates a configuration of a service providing system;

FIG. 2 illustrates a functional configuration of an authentication apparatus;

FIG. 3 is a flowchart of a login process performed by the authentication apparatus;

FIG. 4 is a flowchart of a logout process performed by the authentication apparatus;

FIG. 5 illustrates a functional configuration of an image forming apparatus;

FIG. 6 illustrates a functional configuration related to a service providing process;

FIG. 7 is a flowchart of a login and logout process performed by the image forming apparatus;

FIG. 8 illustrates an example of a displayed operation screen on which the identification number is entered;

FIG. 9 is a ladder chart illustrating communication between the image forming apparatus and the authentication apparatus;

FIG. 10 is a flowchart of the service providing process; and

FIG. 11 is a flowchart of a billing process.

### DETAILED DESCRIPTION

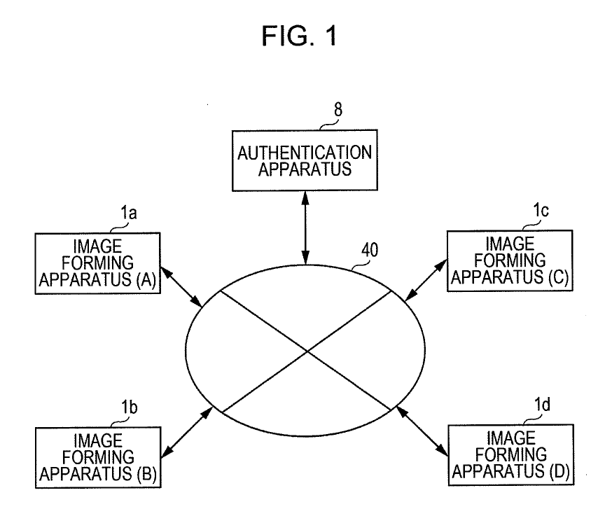

In a service providing system illustrated in FIG. 1, each of plural image forming apparatuses (A) to (D) 1a to 1d provides a user with services of a copy function, a print function, a scan function, and a facsimile (FAX) function, whereas an authentication apparatus 8 is an authentication server that performs authentication of users of the image forming apparatuses (A) to (D) 1a to 1d.

The authentication apparatus 8 and the image forming apparatuses (A) to (D) 1a to 1d are connected to, for example, a local area network (LAN) 40, and performs communication related to an authentication process by using a protocol, such as Kerberos. This authentication process permits plural users to log in from the image forming apparatuses (A) to (D) 1a to 1d and to receive services at the same time. The users who have logged in are permitted to use the image forming apparatuses (A) to (D) 1a to 1d for free unless the users perform a logout operation in the image forming apparatuses (A) to (D) 1a to 1d or terminal apparatuses connected to the image forming apparatuses (A) to (D) 1a to 1d.

Although the image forming apparatuses 1a to 1d are used as the service providing apparatuses in this exemplary embodiment, the service providing system is not limited to this particular example and may include an application service provider (ASP) server that provides services via the Internet and terminal apparatuses used for receiving the provided services. Additionally, kinds of the provided services are not limited to the multiple kinds described above, and one kind of service may be provided.

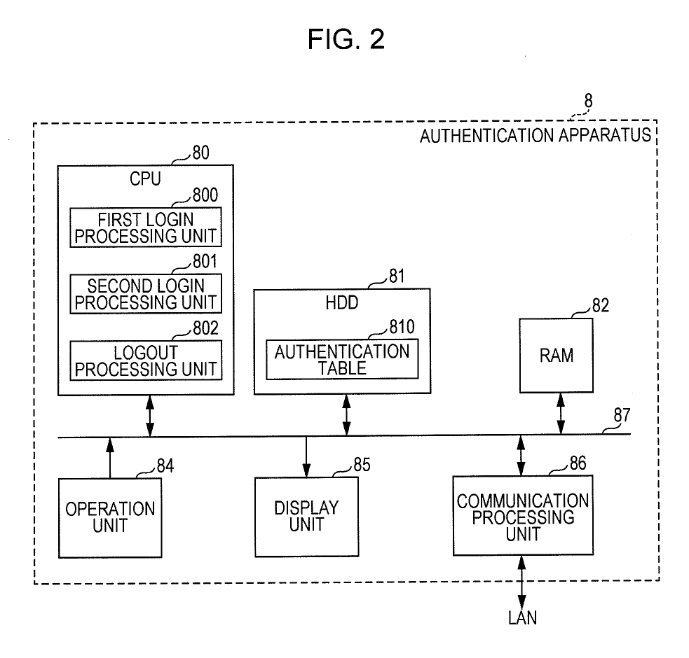

First, the authentication apparatus 8 will be described with reference to FIG. 2. The authentication apparatus 8 includes a central processing unit (CPU) 80, a hard disk drive (HDD) 81, a random access memory (RAM) 82, an operation unit 84, a display unit 85, and a communication processing unit 86.

The CPU 80 is a processing circuit that controls the authentication apparatus 8, and performs a user authentication process. The HDD 81 stores a program that causes the CPU 80 to operate. The RAM 82 is a working memory used by the CPU 80 to operate on the basis of the program. Although the authentication apparatus 8 in this exemplary embodiment functions on the basis of software in this manner, the authentication apparatus 8 may be configured by hardware including an application specific integrated circuit (ASIC).

The operation unit 84 includes information input devices, such as a keyboard and a mouse. The display unit 85 is an image displaying device, such as a display. The communication processing unit 86 is a communication unit that communicates with an external apparatus, is connected to the LAN 40, and includes a circuit that processes communication with the image forming apparatuses 1a to 1d. The CPU 80, the HDD 81, the RAM 82, the operation unit 84, the display unit 85, and the communication processing unit 86 are interconnected via a bus 87.

Upon loading a program, the CPU 80 creates first and second login processing units 800 and 801 that perform a user login process, and a logout processing unit 802 that performs a user logout process as functional units thereof. Each of the first and second login processing units 800 and 801 authenticates a user on the basis of identification information for identifying the user.

TABLE 1

| User | ID No. |
|---|---|
| Robert Smith | 12300010 |
| Patricia Johnson | 00001500 |
| John Brown | 00001090 |
| Andrew Williams | 12500830 |
| Richard Davis | 00001062 |
| Thomas Miller | 00001604 |
| Jessica Anderson | 00001411 |
| David Wilson | 10100526 |
| Chris Parker | 00001007 |
| Stephanie Jones | 00001798 |

For example, identification (ID) numbers illustrated in Table 1 may be used as the identification information. The ID number is a unique number assigned to each user. The identification information is not limited to such an ID number, and may be a character string including letters such as alphabets.

TABLE 2

| First authentication | | | Second authentication |
|---|---|---|---|
| information | | Login | information |
| First ID No. | Password | information | Second ID No. |
| 12300010 | AD96SQ | IN | 00001500 |
| | | | 00001090 |
| 12500830 | RT503W | OUT | 00001062 |
| | | | 00001604 |
| 10100526 | XZC556 | IN | 00001090 |
| | | | 00001007 |
| | | | 00001798 |

As illustrated in Table 2, the HDD 81 stores an authentication table 810 used by the first and second login processing units 800 and 801 to perform an authentication process. Referring to Table 2, “IN” in a login information column indicates a logged in state, whereas “OUT” in the login information column indicates a logged out state.

In the authentication table 810, first authentication information, login information, and one or more pieces of second authentication information are recorded in association with each other. The login information indicates whether a user related to the first authentication information has logged in (the logged in state) or logged out (the logged out state). The one or more pieces of second authentication information are different from the first authentication information. The first authentication information includes a first ID number and a password, whereas the second authentication information includes a second ID number. The first and second ID numbers are registered so that these ID numbers do not coincide with one another in order to allow rights of users to be distinguished from one another. Meanwhile, an administrator is permitted to rewrite these registered contents using the operation unit 84.

The first login processing unit 800 compares an ID number and a password received along with a login request from one of the image forming apparatuses 1a to 1d via the communication processing unit 86, with the first authentication information by referring to the authentication table 810. Meanwhile, a login request is sent once a user performs an operation to allow one of the image forming apparatuses 1a to 1d to recognize their ID number.

If the received ID number and password match the first ID number and the password of the first authentication information as a result of comparison, respectively, the first login processing unit 800 rewrites the login information associated with the first authentication information to the logged in state, and notifies the corresponding one of the image forming apparatuses 1a to 1d of successful authentication via the communication processing unit 86. On the other hand, if at least one of the ID numbers and the passwords do not match as a result of comparison, the first login processing unit 800 requests the second login processing unit 801 to perform an authentication process.

For example, regarding users “Robert Smith” and “Andrew Williams” illustrated in Table 1, their ID numbers are registered as the first authentication information in the authentication table 810. If the entered password matches the password registered in the authentication table 810, these users are authenticated (i.e., authentication is successful). If the passwords do not match, these users are not authenticated (i.e., authentication is unsuccessful). The login information for “Robert Smith” and “Andrew Williams” is rewritten to the logged in state when authentication is successful.

As described above, the ID number and the password are used as the first authentication information in terms of security in this exemplary embodiment, but the ID number alone may be used. In this case, regarding users whose ID numbers are registered as the first authentication information in the authentication table 810, such as “Robert Smith” and “Andrew Williams” illustrated in Table 1, authentication of these users is successful without the password.

In response to a request from the first login processing unit 800, the second login processing unit 801 compares the identification information received along with the login request from the one of the image forming apparatuses 1a to 1d via the communication processing unit 86, with the one or more pieces of second authentication information by referring to the authentication table 810. If the received ID number matches one of the one or more second ID numbers as a result of comparison and the login information associated with the matching second authentication information indicates the logged in state, the second login processing unit 801 notifies the corresponding one of the image forming apparatuses 1a to 1d of successful authentication via the communication processing unit 86. That is, authentication of a user associated with the second ID number is successful only when a user associated with the corresponding first ID number has been authenticated and has already logged in.

For example, the ID number of the user “Robert Smith” illustrated in Table 1 is registered as the first authentication information and he has already logged in. Accordingly, authentication of “Patricia Johnson” and “John Brown” having the second ID numbers that are associated with the ID number of “Robert Smith” is successful and they are permitted to log in.

In another example, regarding the user “Andrew Williams” illustrated in Table 1, his ID number is registered as the first authentication information but he has logged out. Accordingly, authentication of “Richard Davis” and “Thomas Miller” having the second ID numbers that are associated with the ID number of “Andrew Williams” is unsuccessful and they are not permitted to log in.

As is clear from Table 2, the ID number of “John Brown” is registered as the second authentication information in association with the ID numbers of “Robert Smith” and “David Wilson”. Thus, when “Robert Smith” or “David Wilson” has been authenticated and logged in, authentication of “John Brown” is successful. Alternatively, authentication of “John Brown” may be unsuccessful unless both “Robert Smith” and “David Wilson” have been authenticated and logged in.

Although the second authentication information does not include the password in this exemplary embodiment, the password may be included. In this case, the second login processing unit 801 compares the ID number and the password received from the image forming apparatuses 1a to 1d with the second ID number and the password included in the second authentication information, respectively. If both the ID numbers and the passwords match as a result of comparison and the login information associated with the matching second authentication information indicates the logged in state, the second login processing unit 801 notifies the corresponding image forming apparatuses 1a to 1d of successful authentication.

The logout processing unit 802 compares identification information received along with a logout notification from one of the image forming apparatuses 1a to 1d via the communication processing unit 86, with the first authentication information by referring to the authentication table 810. If the identification information matches the first authentication information, the logout processing unit 802 rewrites the login information associated with the first authentication information to the logged out state. A logout notification is sent in response to an operation performed in the image forming apparatuses 1a to 1d or a terminal apparatus, such as a personal computer, capable of communicating with the image forming apparatuses 1a to 1d. As described above, when the login information indicates the logged out state, a user associated with the corresponding second ID number is not permitted to log in.

For example, the ID numbers of the users “Robert Smith”, “Andrew Williams”, and “David Wilson” illustrated in Table 1 are registered as the first authentication information. Thus, if they log out, the corresponding login information is rewritten to the logged out state. On the other hand, the ID numbers of the users “Patricia Johnson” and “John Brown” are not registered as the first authentication information but as the second authentication information. Thus, if they log out, no information is updated. Alternatively, the authentication apparatus 8 may manage login information of users registered regarding the second authentication information to indicate the logged in state or the logged out state.

For example, regarding a university, users who are registered in relation to the first authentication information in the authentication table 810 are desirably professors and associate professors, whereas users who are registered in relation to the second authentication information are desirably students. In this case, students are permitted to log in as long as their professor or associate professor has already logged in. Thus, the plural image forming apparatuses 1a to 1d may be used simultaneously on a laboratory-by-laboratory basis, for example.

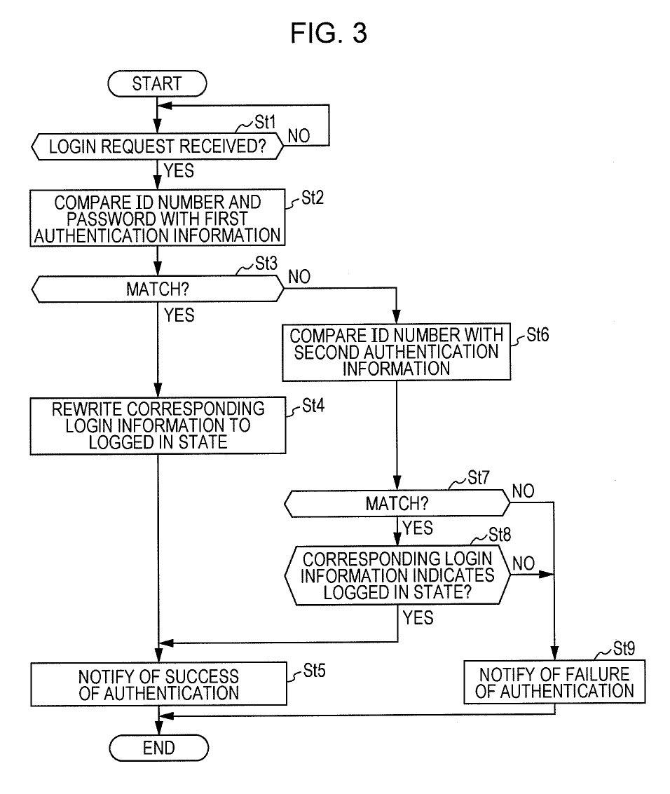

Now, a process performed by the first and second login processing units 801 and 802, respectively, will be described with reference to FIG. 3. Upon receiving a login request from one of the image forming apparatuses 1a to 1d (YES in step St1), the first login processing unit 800 compares the ID number and the password included in the login request with the first ID number and the password of the first authentication information stored in the authentication table 810 (step St2).

If the ID number and the password match the first authentication information as a result of comparison (YES in step St3), the first login processing unit 800 rewrites the login information corresponding to the first authentication information to the logged in state (step St4). The first login processing unit 800 then notifies the corresponding one of the image forming apparatuses 1a to 1d that has sent the login request, of successful authentication (step St5).

On the other hand, if at least one of the ID number and the password does not match the first authentication information as a result of comparison (NO in step St3), the second login processing unit 801 compares the ID number included in the login request with the second ID number of the second authentication information stored in the authentication table 810 (step St6). If the ID number matches the second authentication information as a result of comparison (YES in step St7), the second login processing unit 801 checks the login information associated with this second authentication information (step St8).

If the associated login information indicates the logged in state (YES in step St8), the second login processing unit 801 notifies the corresponding one of the image forming apparatuses 1a to 1d of successful authentication (step St5). On the other hand, if the associated login information indicates the logged out state (NO in step St8), the second login processing unit 801 notifies the corresponding one of the image forming apparatuses 1a to 1d that has sent the login request, of unsuccessful authentication (step St9). This step is similarly performed if the received ID number does not match the second authentication information as a result of comparison (NO in step St7). Although the first login processing unit 800 and then the second login processing unit 801 perform the authentication process in the above-described flow, the processing order is not limited to this particular example.

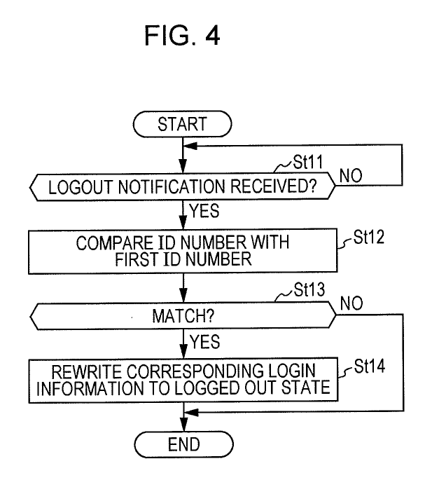

Now, a process performed by the logout processing unit 802 will be described with reference to FIG. 4. Upon receiving a logout notification from one of the image forming apparatuses 1a to 1d (YES in step St11), the logout processing unit 802 compares the ID number included in the logout notification with the first ID number of the first authentication information stored in the authentication table 810 (step St12).

If the received ID number matches the first authentication information as a result of comparison (YES in step St13), the logout processing unit 802 rewrites the login information corresponding to the first authentication information to the logged out state (step St14).

With the authentication apparatus 8 described above, when there is a user who has been authenticated on the basis of the first authentication information and has already logged in, another user is authenticated on the basis of the second authentication information associated with the first authentication information and is permitted to log in. Thus, when a specific user has already logged in, one or more other users are permitted to log in and use the image forming apparatuses 1a to 1d at the same time.

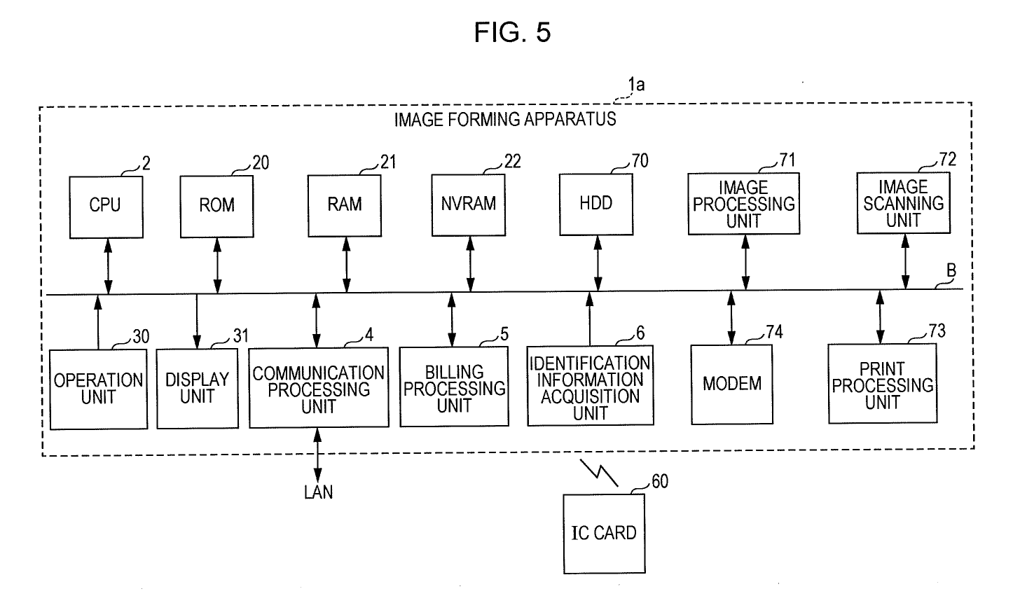

Now, functional configurations of the image forming apparatuses 1a to 1d will be described with reference to FIG. 5. Although FIG. 5 illustrates the image forming apparatus 1a, the other image forming apparatuses 1b to 1d have the same configuration.

The image forming apparatus 1a includes a CPU 2, a read only memory (ROM) 20, a RAM 21, a nonvolatile RAM (NVRAM) 22, an operation unit 30, a display unit 31, and a communication processing unit 4.

The CPU 2 is a processing circuit that controls the image forming apparatus 1a, and performs processes, such as a service providing process which includes processing regarding authentication of a user and execution of the copy function and so forth. The ROM 20 stores a program that causes the CPU 2 to operate. The RAM 21 is a working memory used by the CPU 2 to operate on the basis of this program. Although the image forming apparatus 1 in this exemplary embodiment functions on the basis of software in this manner, the image forming apparatus 1 may be configured by hardware including an ASIC.

The NVRAM 22, e.g., a flash memory, stores parameters regarding operation settings of the image forming apparatus 1a. The operation unit 30 includes buttons used by a user to instruct the image forming apparatus 1a to execute the copy function and so forth, an input device used for entering information, such as identification information and a password, and a touch panel used for selecting a service to be provided. The display unit 31 is a liquid crystal panel used for notifying a user of information, and may be used along with the touch panel stacked thereon, for example.

The communication processing unit 4 is a communication unit that communicates with an external apparatus, is connected to the LAN 40, and includes a circuit that processes communication with the foregoing authentication apparatus 8 or the like, for example.

The image forming apparatus 1a also includes a billing processing unit 5, an identification information acquisition unit 6, an HDD 70, an image processing unit 71, an image scanning unit 72, a modem 74, and a print processing unit 73.

The billing processing unit 5 serves as a payment accepting device that accepts payment from a user and is constituted by a device called “CoinKit”, for example. Specifically, the billing processing unit 5 includes slots that receive coins and banknotes, a detector that detects entry of coins and banknotes, an addition unit that calculates a sum of the entered money as a deposited amount, a subtraction unit that subtracts a fee for a service when the service is provided, and a returning unit that returns the remaining deposited amount.

For example, the billing processing unit 5 is connected to the image forming apparatus 1 via a serial interface, such as RS-232C. However, the billing processing unit 5 is not limited to this particular example, and may be integrally formed in the image forming apparatus 1 or may be constituted as a billing server connected to the LAN 40. In this case, the billing server accepts payment for a fee by receiving a payment request sent by the image forming apparatus 1 via the communication processing unit 4. The billing server then charges a user for the fee by using a prepaid card or by sending a bill for the fee.

The identification information acquisition unit 6 acquires identification information for identifying a user, and is, for example, an IC card reader that reads identification information from an IC card 60 of a user by using near field communication (NFC). The ID number described in Table 1 may be used as the identification information. The identification information acquisition unit 6 is connected to the image forming apparatus 1 via an interface, such as a universal serial bus (USB).

Before a user uses the image forming apparatus 1a, the user places the IC card 60 over the identification information acquisition unit 6 to allow the image forming apparatus 1a to recognize their ID number. However, the identification information acquisition unit 6 may be constituted by another device that acquires the identification information. Specifically, for example, a device may be adopted that reads identification information from a magnetic card or a mobile terminal device, such as a smartphone or mobile phone, of a user.

Furthermore, a device called “IC card cashier” having the identification information acquisition function and the function of the aforementioned billing processing unit 5 may be adopted. In this case, the identification information acquisition unit 6 and the billing processing unit 5 are integrated. Additionally, the billing processing unit 5 accepts payment which is made with an amount of money charged up on the IC card 60 instead of coins or the like.

The HDD 70 stores image data or the like when a service is provided. The image processing unit 71 decompresses and compresses image data when a service is provided. The image scanning unit 72 scans an image to generate image data when the copy function is executed. The modem 74 is connected to a telephone line and performs fax communication when the fax function is executed. The print processing unit 73 prints an image of image data received via the LAN 40 when the print function is executed.

The CPU 2, the ROM 20, the RAM 21, the NVRAM 22, the operation unit 30, the display unit 31, the communication processing unit 4, the billing processing unit 5, the identification information acquisition unit 6, the HDD 70, the image processing unit 71, the image scanning unit 72, the print processing unit 73, and the modem 74 are electrically interconnected via a bus B.

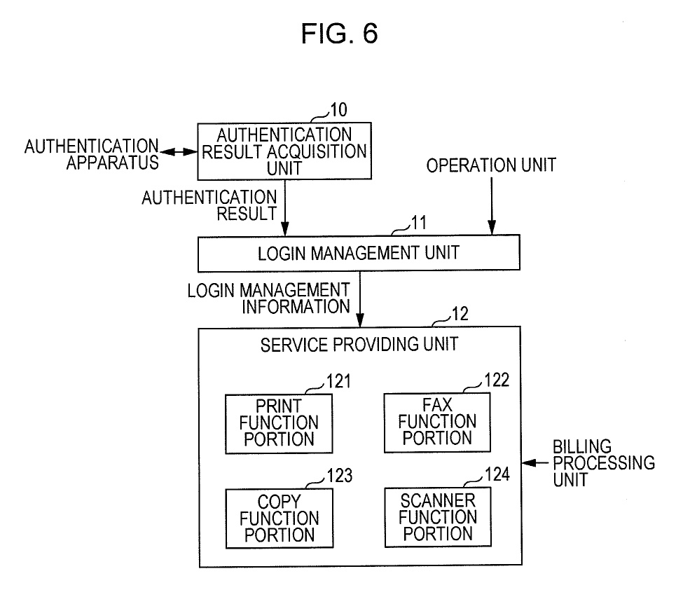

Now, functions of the CPU 2 for permitting to provide a service will be described with reference to FIG. 6. Upon loading a program stored in the ROM 20, the CPU 2 creates an authentication result acquisition unit 10, a login management unit 11, and a service providing unit 12 as functional units thereof.

As illustrated in FIG. 9, the authentication result acquisition unit 10 sends, to the authentication apparatus 8 via the communication processing unit 4, identification information acquired by the identification information acquisition unit 6 and the password entered with the operation unit 30 so as to request a user login process, and acquires a result of authentication. Meanwhile, the authentication result acquisition unit 10 may send identification information entered by a user with the operation unit 30 instead of the identification information acquired by the identification information acquisition unit 6.

The authentication result acquisition unit 10 notifies the login management unit 11 of the result of authentication acquired from the authentication apparatus 8. The login management unit 11 rewrites login management information which indicates the logged in state or the logged out state of the user to the logged in state if the authentication result acquisition unit 10 acquires a result indicating successful authentication, or rewrites the login management information to the logged out state in response to a user operation. A user may log out using the operation unit 30 or by operating a terminal apparatus, such as a PC, connected to the image forming apparatus 1a, for example.

The service providing unit 12 provides a service to a user when the login management information indicates the logged in state. The service providing unit 12 includes a print function portion 121 that executes the print function, a fax function portion 122 that executes the fax function, a copy function portion 123 that executes the copy function, and a scanner function portion 124 that executes the scanner function. Each of the function portions 121 to 124 controls the aforementioned units 70 to 74 in accordance with a service selected by a user with the operation unit 30.

The service providing unit 12 provides a service once the billing processing unit 5 accepts payment even when the login management information indicates the logged out state. At this time, kinds of selectable services are limited.

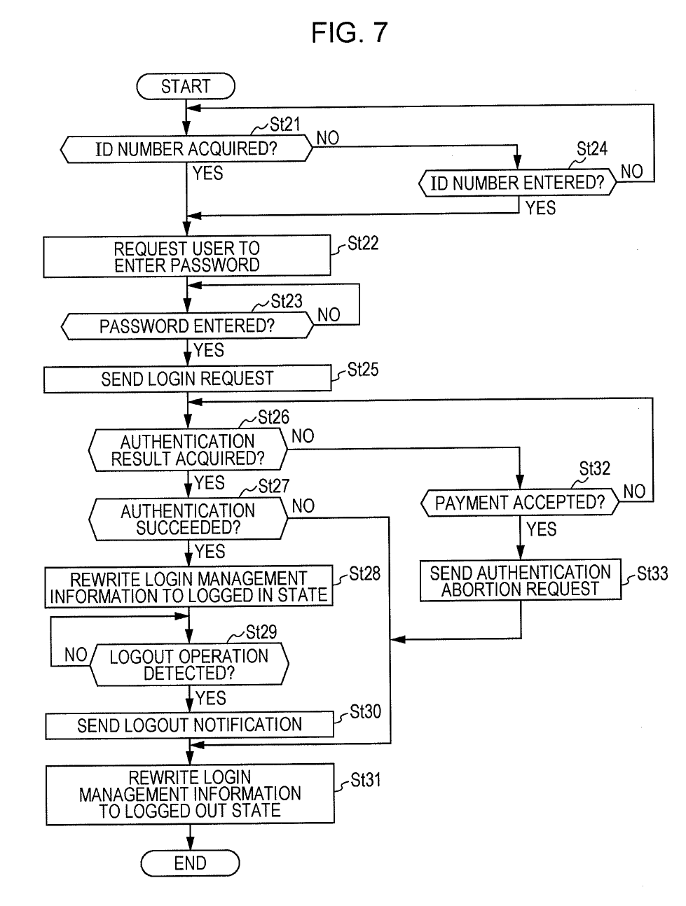

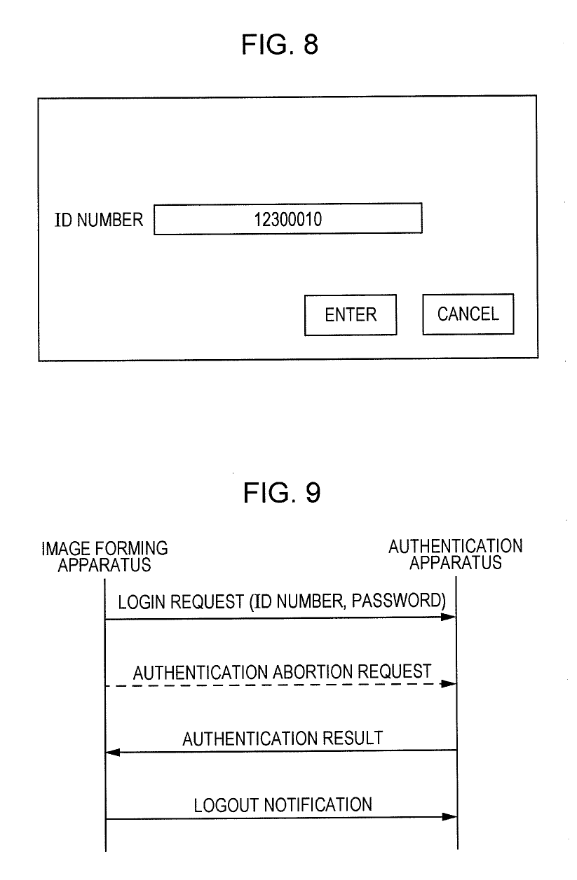

Next, a process of permitting a service performed by the CPU 2 will be described with reference to FIG. 7. First, a user places the IC card 60 over the identification information acquisition unit 6, whereby the identification information acquisition unit 6 acquires the ID number of the user (YES in step St21). The ID number may be acquired in a manner as follows: a screen illustrated in FIG. 8 is displayed on the display unit 31; and a user enters their ID number using the operation unit 30 (NO in step St21 and YES in step St24). Thus, even when the user does not carry their IC card 60, the image forming apparatus 1a acquires the identification information via the operation unit 30. The image forming apparatus 1a may include a unit for biometric authentication, such as fingerprint authentication, instead of or along with an input unit for receiving identification information from the operation unit 30, thereby acquiring the identification information.

Upon acquiring the ID number (YES in step St21 or YES in step St24), the display unit 31 displays a message that requests the user to enter their password (step St22). Once the user enters their password using the operation unit 30 (YES in step St23), the authentication result acquisition unit 10 sends, to the authentication apparatus 8, the ID number and the password along with a login request so as to request a user login process, as described with reference to FIG. 9 (step St25). In response to the request, the authentication apparatus 8 performs an authentication process on the basis of the authentication table 810 illustrated in Table 2, and notifies the image forming apparatus 1a of a result of authentication as described above.

The authentication process ends once the image forming apparatus 1a receives the authentication result from the authentication apparatus 8 (YES in step St26). When authentication is successful (YES in step St27), the login management unit 11 rewrites the login management information to the logged in state (step St28). In this manner, the function portions 121 to 124 of the service providing unit 12 are ready to operate.

If a user enters a logout instruction using the operation unit 30 or a terminal apparatus, such as a PC, connected via the LAN 40 in a communication performable manner (YES in step St29), the login management unit 11 sends a logout notification to the authentication apparatus 8 as illustrated in FIG. 9 (step St30) and rewrites the login management information to the logged out state (step St31). This step is similarly performed when authentication is unsuccessful (NO in step St27).

Once the billing processing unit 5 accepts payment (YES in step St32) before the authentication apparatus 8 completes the authentication process (NO in step St26), the authentication result acquisition unit 10 sends a request to abort the authentication process to the authentication apparatus 8 as indicated by a broken line in FIG. 9 (step St33). Upon receiving the request, the authentication apparatus 8 aborts the authentication process. Here, upon accepting payment, the billing processing unit 5 notifies the authentication result acquisition unit 10 of acceptance of payment.

Then, the login management unit 11 assumes that authentication based on the authentication table 810 is unsuccessful and rewrites the login management information to the logged out state (step St31). This allows the user to save time taken for authentication and to receive provided services by making payment. The process performed when authentication is aborted is not limited to this particular example. For example, the billing processing unit 5 is notified of abortion of authentication. Upon receiving this notification, the billing processing unit 5 may return the deposited money to the user.

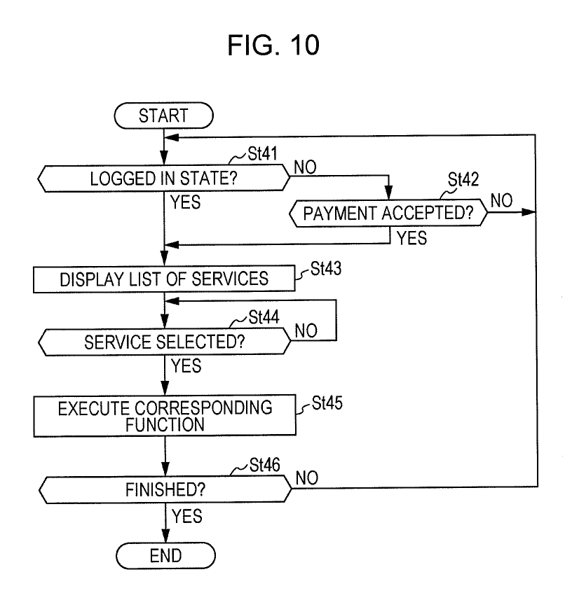

Next, the process performed by the service providing unit 12 will be described with reference to FIG. 10. When the login management information indicates the logged in state (YES in step St41) or when the login management information indicates the logged out state (NO in step St41) but payment is accepted (YES in step St42), the service providing unit 12 displays a list of services on the display unit 31 (step St43).

TABLE 3

| Function | Available/Not Available |
|---|---|
| Copy | Available |
| Print | Available |
| Fax | Not Available |
| Scan | Not Available |

The service providing unit 12 displays a list of accessible services on the display unit 31 with reference to a management table illustrated in Table 3 (step St43). The function attached with “Available” in Table 3 is accessible, whereas the function attached with “Not Available” is not accessible.

When the login management information indicates the logged in state, the service providing unit 12 sets all services to be accessible (“Available”). On the other hand, when payment is accepted, the service providing unit 12 sets the fax function and the scan function not to be accessible (“Not Available”). In this case, a user is unable to select these functions. In this manner, the image forming apparatus 1a changes kinds of services provided to the user depending on whether authentication has been successful or not. Meanwhile, the kinds of functions that are set not to be accessible are not limited to those illustrated in Table 3.

Once the user selects a service using the operation unit 30 (YES in step St44), the service providing unit 12 executes the function for the selected service (step St45). Meanwhile, the user is unable to select the services that are set not to be accessible in Table 3.

When the user selects to continuously use the service using the operation unit 30, the service providing unit 12 performs the process from step St41 again (NO in step St46). If the user selects to finish using the service by logging out or the like, the process ends (YES in step St46).

In the aforementioned flow, the billing processing unit 5 may accept payment from a user only when the login management information indicates the logged out state (NO in step St41). In this way, a situation is avoided where an already-logged-in user accidentally makes payment. Alternatively, even when the login management information indicates the logged in state, the billing processing unit 5 may accept payment in case for private use.

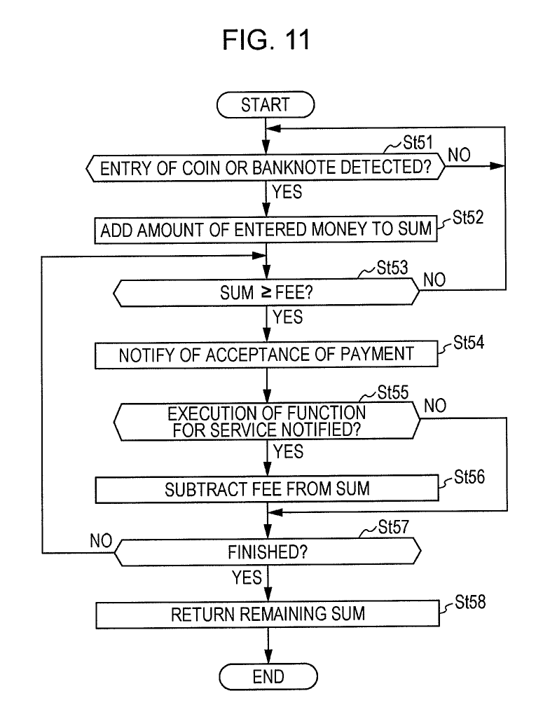

Next, a process performed by the billing processing unit 5 will be described with reference to FIG. 11. Upon detecting entry of a coin or a banknote to the slot (YES in step St51), the billing processing unit 5 determines a sum of entered money as a deposited amount of the user (step St52). When electronic money or a prepaid card is used, these steps are skipped.

Once the deposited amount is equal to or greater than a fee for the service (YES in step St53), the billing processing unit 5 notifies the service providing unit 12 of the acceptance of payment (step St54). On the other hand, if the deposited amount is less than the fee for the service (NO in step St53), steps St51 and St52 are repeated.

Next, upon being notified of execution of the function for the service by the service providing unit 12 (step St55), the billing processing unit 5 subtracts the fee for the service from the deposited amount (step St56).

When the user selects to continuously use the service with the operation unit 30, the billing processing unit 5 performs the process from step St53 again (NO in step St57). When the user selects to finish using the service through a logout operation or the like (YES in step St57), the billing processing unit 5 returns the money left over to the user and terminates the process (step St58). This step is similarly performed when the function of the service is not executed within a specific period after acceptance of payment (NO in step St55).

As described above, with the image forming apparatuses 1a to 1d according to this exemplary embodiment, when there is a user who has been authenticated by the authentication apparatus 8 on the basis of the first authentication information and has already logged in, other users are authenticated on the basis of the second authentication information associated with the first authentication information and are permitted to log in. The users having the second identification information are permitted to use the image forming apparatuses 1a to 1d even after the user having the first identification information logs out unless they log out. Additionally, users are capable of using services by making payment when authentication is unsuccessful and the users are not permitted to login.

In this exemplary embodiment, users are authenticated by the external authentication apparatus 8. Instead of the authentication apparatus 8, one of the image forming apparatuses 1a to 1d may include the authentication table 810 and perform authentication.

TABLE 4

| | | | Second | | Third |
|---|---|---|---|---|---|
| First | | | authen- | | authen- |
| authentication | | First | tication | Second | tication |
| information | | login | information | login | information |
| First | Pass- | infor- | Second | infor- | Third |
| ID No. | word | mation | ID No. | mation | ID No. |
| 12300010 | AD96SQ | IN | 00001500 | OUT | 00001411 |
| | | | 00001090 | IN | 00001301 |
| | | | | | 00001366 |
| 12500830 | RT503W | OUT | 00001062 | OUT | 00002057 |
| | | | | | 00002563 |
| | | | 00001604 | OUT | 00002057 |
| 10100526 | XZC556 | IN | 00001090 | IN | 00002563 |
| | | | 00001007 | OUT | 00001488 |
| | | | 00001798 | IN | 00001555 |

Although the authentication table 810 in which two kinds of authentication information are associated has been described in this exemplary embodiment, the authentication table 810 is not limited to this particular example. For example, as illustrated in Table 4, second login information indicating the logged in state or the logged out state based on the second authentication information and one or more pieces of third authentication information that are different from the first and second authentication information are also associated in addition to the items of Table 2. Here, the third authentication information includes a third ID number.

In this case, the authentication processes based on the first and second authentication information are performed in a manner described above and an authentication process based on the third authentication information is additionally performed. The authentication process based on the third authentication information is the same as that based on the second authentication information. Specifically, when authentication based on the first and second authentication information is unsuccessful but the received ID number matches one of the third ID numbers, the corresponding second login information is referred to. If the second login information indicates the logged in state, authentication is successful. If the second login information indicates the logged out state, authentication is unsuccessful.

For example, the ID number of “Patricia Johnson” illustrated in Table 1 is registered as the second authentication information, and the corresponding second login information indicates the logged out state. Accordingly, authentication of a user having the third ID number “00001411” is unsuccessful.

Additionally, the ID number of “John Brown” illustrated in Table 1 is registered as the second authentication information, and the corresponding second login information indicates the logged in state. Accordingly, authentication of users having the third ID numbers “00001301”, “00001366”, and “00002563” is successful.

There is no restriction on the numbers of pieces of authentication information and pieces of login information that are associated with each other in the authentication table 810, and authentication may be controlled in stages depending on the kinds of rights granted to users.

Desirable effects similar to those offered by the exemplary embodiment that has been described above may be obtained by supplying an authentication apparatus and a service providing apparatus with a recording medium storing a program for implementing the aforementioned various functions and by executing the program with computers of the authentication apparatus and the service providing apparatus. Meanwhile, the recording medium may be of any type, such as a compact disc-read only memory (CD-ROM), a digital versatile disc (DVD), or an SD card, as long as the recording medium is computer readable.

While contents of the present invention have been concretely described above with reference to the exemplary embodiment, those skilled in the art may understand that various modifications may occur on the basis of the basic technical spirits and teachings of the present invention.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An authentication apparatus comprising:
an authentication table in which first authentication information, login information, and one or more pieces of second authentication information are stored in association with each other, the login information indicating a logged in state or a logged out state of a user related to the first authentication information, the one or more pieces of second authentication information being different from the first authentication information;
a communication unit that communicates with another apparatus;
a first login processing unit that
compares identification information received along with a login request from the other apparatus via the communication unit, with the first authentication information by referring to the authentication table, and
when the identification information matches the first authentication information, rewrites the login information associated with the first authentication information to the logged in state and notifies the other apparatus of successful authentication via the communication unit;
a logout processing unit that
compares identification information received along with a logout notification from the other apparatus via the communication unit, with the first authentication information by referring to the authentication table, and
rewrites the login information associated with the first authentication information to the logged out state when the identification information matches the first authentication information; and
a second login processing unit that
compares the identification information received along with the login request from the other apparatus via the communication unit, with the one or more pieces of second authentication information by referring to the authentication table, and
notifies the other apparatus of successful authentication via the communication unit when the identification information matches a piece of second authentication information among the one or more pieces of second authentication information and the login information associated with the first authentication information that is associated with the matching piece of second authentication information indicates the logged in state.

2. A service providing system comprising:
the authentication apparatus according to claim 1; and
one or more service providing apparatuses, each including
an identification information acquisition unit that acquires identification information of a user,
a communication unit that communicates with another apparatus,
an authentication result acquisition unit that sends the identification information acquired by the identification information acquisition unit to the authentication apparatus via the communication unit along with a login request, and acquires a result of authentication via the communication unit,
a logout notification unit that sends the identification information along with a logout notification to the authentication apparatus via the communication unit,
a login management unit that
rewrites login management information indicating a logged in state or a logged out state of a user to the logged in state when the authentication result acquisition unit acquires a result indicating successful authentication of the user, and
rewrites the login management information to the logged out state in response to an operation by the user, and
a service providing unit that provides a service to a user when the login management information related to the user indicates the logged in state.

3. The service providing system according to claim 2, further comprising
a payment accepting device that accepts payment from a user,
wherein when the login management information indicates the logged out state and the payment accepting device accepts payment, the service providing unit provides a service to the user.

4. A computer readable medium storing a program causing a computer to execute a process for authentication, the process comprising:
storing first authentication information, login information, and one or more pieces of second authentication information in association with each other in an authentication table, the login information indicating a logged in state or a logged out state of a user related to the first authentication information, the one or more pieces of second authentication information being different from the first authentication information;
communicating with another apparatus;
comparing identification information received along with a login request from the other apparatus, with the first authentication information by referring to the authentication table;
when the identification information matches the first authentication information, rewriting the login information associated with the first authentication information to the logged in state and notifying the other apparatus of successful authentication;
comparing the identification information received along with the login request from the other apparatus, with the one or more pieces of second authentication information by referring to the authentication table;
notifying the other apparatus of successful authentication when the identification information matches a piece of second authentication information among the one or more pieces of second authentication information and the login information associated with the first authentication information that is associated with the matching piece of second authentication information indicates the logged in state;
comparing identification information received along with a logout notification from the other apparatus, with the first authentication information by referring to the authentication table; and
rewriting the login information associated with the first authentication information to the logged out state when the identification information matches the first authentication information.
